(19) United States
(12) Patent Application Publication
(10) Pub. No.: US 2021/0376520 A1
(43) Pub. Date: Dec. 2, 2021

(54) CABLE SECURING APPARATUS

(71) Applicant: Geddy's Mom LLC

(72) Inventors: Sarah Shell, Watchung, NJ (US); Eric Cohen, Watchung, NJ (US)

(73) Assignee: Geddy's Mom LLC

(21) Appl. No.: 17/330,156

(22) Filed: May 25, 2021

Related U.S. Application Data
(60) Provisional application No. 63/030,102, filed on May 26, 2020.

(51) Int. Cl. H01R 13/60

(52) U.S. Cl. CPC H01R 13/60

(57) ABSTRACT

A cable securing apparatus comprises a container. The container includes a space, at least one entry aperture, a cover, and a closure. The space is configured to accept a portion of a cable with an end terminal. The at least one entry aperture is configured to accept the portion of a cable with the end terminal. The at least one entry aperture facilitates entry of the portion of the cable with the end terminal into the space from outside of the container and prevents the end terminal from sliding out of the at least one entry aperture. The cover is rotatably securable to the container such that the portion of the cable and the end terminal are enclosable within the container. The closure is configured to secure the cover to the container.

### CROSS-REFERENCE TO RELATED APPLICATIONS

This application claims the benefit of U.S. provisional patent application Ser. No. 63/030,102, filed on May 26, 2020, the contents of which are incorporated herein by reference in their entirety.

### BACKGROUND

Charging cables are essential for powering devices found in a user's home. The charging cables typically include a plug for a wall socket or other power source, a wire, and a connector head, which includes the connector lead that couples to a device through its receptacle to charge it. This connector head, which includes the connector lead that couples to a device through its receptacle to charge it, will be referred to as an “end terminal.” In many households it is common to find charging cables connected to a power source without a device plugged in.

Leaving a charging cable plugged in to a power source without a device attached, and thus its connector lead left free, may be a risk to adults, children, animals, and nearby objects. Half of the injuries due to unsecured charging cable ends are to adults, who often fall asleep on or unknowingly sit on the lead for long periods of time and receive scarring ulcerations from this contact. Floors, carpets, beds and couches have also been reported as damaged, being burned or melted through contact with and discharge from a charging cable end. Most importantly, children and pets that play with the power connector head of the charging cable, (including placing the free terminal end in their mouth), run the risk of being electrocuted or burned if the other end of the cable is plugged into a live outlet.

While a potential remedy to the situation would be to unplug the charging cable, there are many instances where a user may not be able to easily unplug the cable or may simply forget, or, most commonly, it does not occur to them that this is a hazard. Therefore, a need exists to protect adults, children, animals such as pets, and surrounding objects from electrical discharge through the free metal connector end of the end terminal of charging cables.

### BRIEF SUMMARY

A cable securing apparatus comprises a container. The container includes a space, at least one entry aperture, a cover, and a closure. The space may be configured to accept a portion of a cable with an end terminal. The at least one entry aperture may be configured to accept the portion of a cable with the end terminal. The at least one entry aperture facilitates entry of the portion of the cable with the end terminal into the space from outside of the container, and prevents the end terminal from sliding out of the at least one entry aperture. The cover may be rotatably securable to the container such that the portion of the cable and the end terminal are enclosable within the container. The closure may be configured to secure the cover to the container.

A method of securing a cable involves placing a portion of a cable with an end terminal into a container and closing a cover on the container, thereby securing the cable and the end terminal. The container may include a space, at least one entry aperture, a cover, and a closure. The space may be configured to accept a portion of a cable with an end terminal. The at least one entry aperture may be configured to accept the portion of a cable with the end terminal. The at least one entry aperture facilitates entry of the portion of the cable with the end terminal into the space from outside of the container, and prevents the end terminal from sliding out of the at least one entry aperture. The cover may be rotatably securable to the container such that the portion of the cable and the end terminal are enclosable within the container. The closure may be configured to secure the cover to the container.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates perspective views of a cable securing apparatus 100 in accordance with one embodiment.

FIG. 2 illustrates rear views of a cable securing apparatus 100 in accordance with one embodiment.

FIG. 3 illustrates front views of a cable securing apparatus 100 in accordance with one embodiment.

FIG. 4 illustrates lateral views of a cable securing apparatus 100 in accordance with one embodiment.

FIG. 5 illustrates top views of a cable securing apparatus 100 in accordance with one embodiment.

FIG. 6 illustrates perspective views of a cable securing apparatus 100 in accordance with one embodiment.

FIG. 7 illustrates perspective views of a cable securing apparatus 100 in accordance with one embodiment.

FIG. 8 illustrates perspective views of a cable securing apparatus 800 in accordance with one embodiment.

FIG. 9 illustrates an aspect of the subject matter in accordance with one embodiment.

FIG. 10 illustrates perspective views of a cable securing apparatus 1000 in accordance with one embodiment.

FIG. 11 illustrates perspective views of a cable securing apparatus 1100 in accordance with one embodiment.

FIG. 12 illustrates perspective views of a cable securing apparatus 1200 in accordance with one embodiment.

FIG. 13A illustrates a top view of a cable securing apparatus 1300 in accordance with one embodiment.

FIG. 13B illustrates a plan view of a cable securing apparatus 1300 in accordance with one embodiment.

FIG. 14 illustrates a cable securing apparatus 1400 in accordance with one embodiment.

FIG. 15 illustrates a cable securing apparatus 1500 in accordance with one embodiment.

FIG. 16 illustrates a cable securing apparatus 1600 in accordance with one embodiment.

FIG. 17A illustrates a hinged-latch snap-fit closure 1700a in accordance with one embodiment.

FIG. 17B illustrates cantilever snap-fit closures 1700b in accordance with one embodiment.

FIG. 17C illustrates an annular snap-fit closure 1700c in accordance with one embodiment.

FIG. 17D illustrates a torsion snap-fit closure 1700d in accordance with one embodiment.

FIG. 17E illustrates a latch-bead snap-fit closure 1700e in accordance with one embodiment.

FIG. 18A illustrates a cable securing apparatus 1800a in accordance with one embodiment.

FIG. 18B illustrates a cable securing apparatus 1800b in accordance with one embodiment.

### DETAILED DESCRIPTION

A cable securing apparatus may be provided to securely enclose an end terminal (e.g., a connector head, which includes the connector lead that couples to a device through its receptacle to charge) of a cable, preventing incidental contact with the end terminal that may cause potential injury or damage. Inadvertent extended skin contact by an adult and contact with fibrous home goods, like furniture, can also be prevented. Even though references are made to protecting children throughout this disclosure, the embodiments may also be used for the protection of adults, pets, small animals, and other items that are at risk for shock, burning, or melting, such as furniture and carpet. “End terminal” refers to a connector that couples to a device to charge it and/or transmit a signal to the device. The cable securing apparatus may prevent a child or small animal from accessing the end terminal through a locking device or mechanism that prevents a child or pet from opening the cable securing apparatus (making it child resistant or child proof). The cable securing apparatus may also provide apertures allowing the cable securing device to retain the cable portion of a cable while enclosing the end terminal. The cable securing apparatus may be constructed of various materials such as, various plastics, metals, ceramics, and combinations thereof, so long as the inner wall is non-conductive. The materials may be such that they are non-toxic and child-safe.

A cable securing apparatus comprises a container. The container includes a space, at least one entry aperture, a cover, and a closure. The space is configured to accept a portion of a cable with an end terminal. The at least one entry aperture is configured to accept the portion of a cable with the end terminal. The at least one entry aperture facilitates entry of the portion of the cable with the end terminal into the space from outside of the container, and prevents the end terminal from sliding out of the at least one entry aperture. The cover is rotatably securable to the container such that the portion of the cable and the end terminal are enclosable within the container. The closure is configured to secure the cover to the container. The container may include a secured cover that configures it as a child resistant container.

In some configurations, a hinge connects the cover to the container.

In some configurations, at least one exit aperture on the container is configured to accept the portion of the cable with the end terminal.

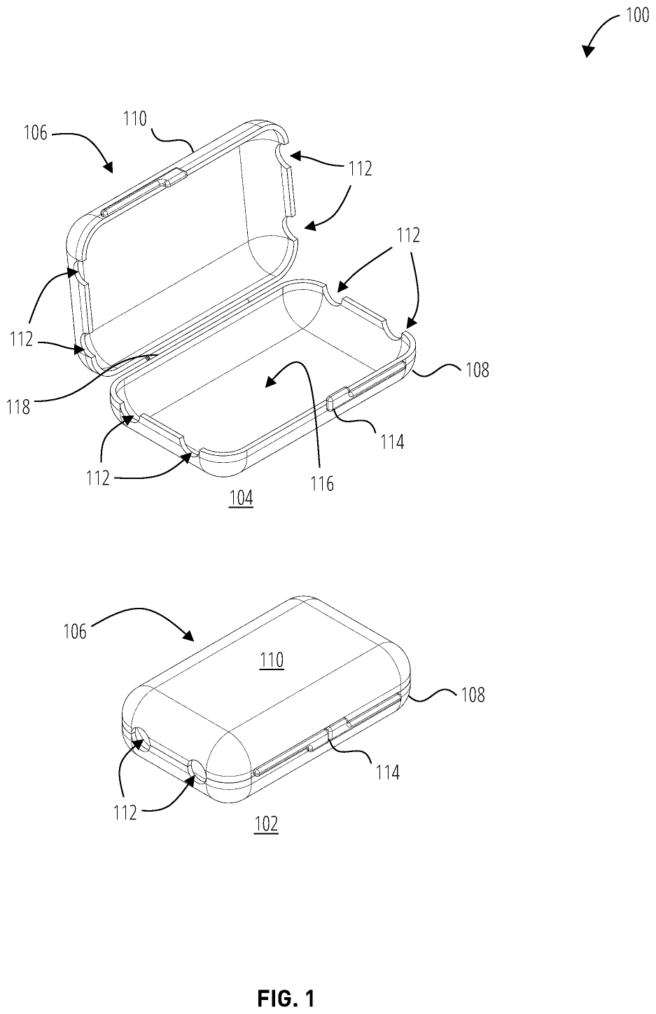

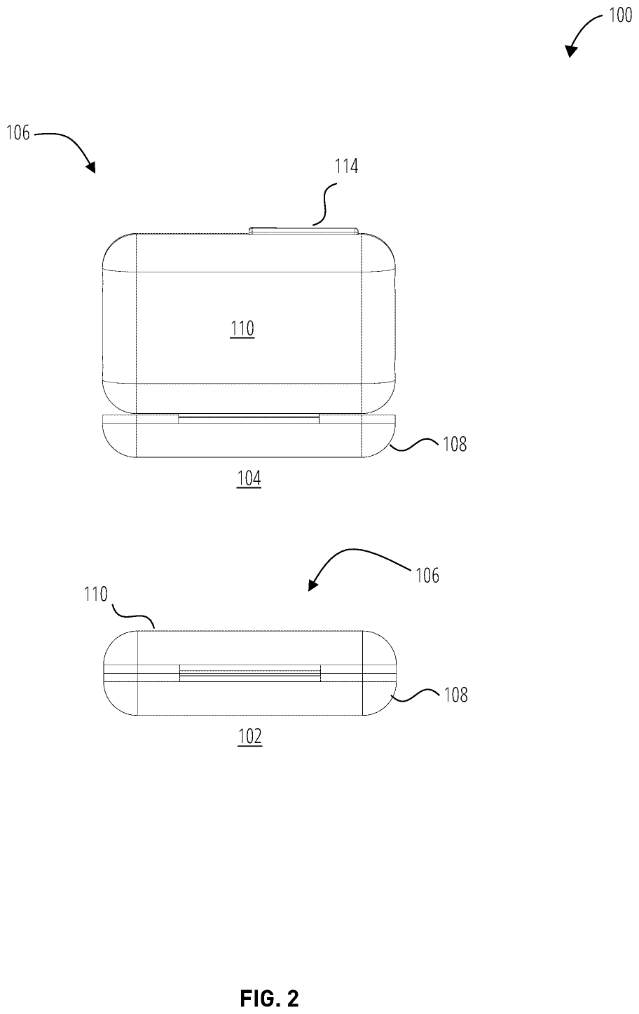

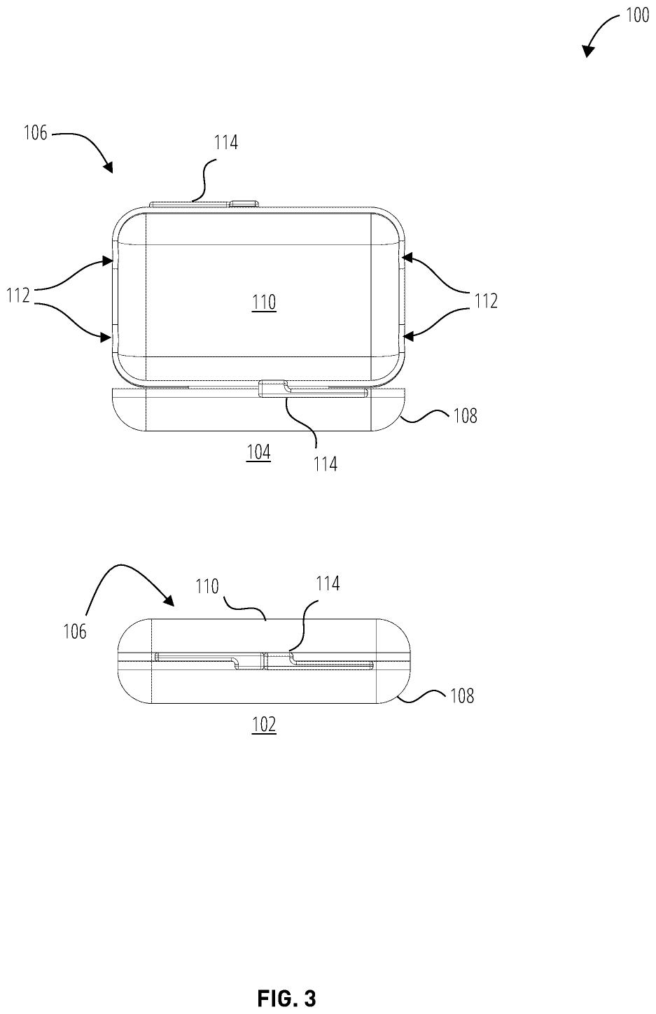

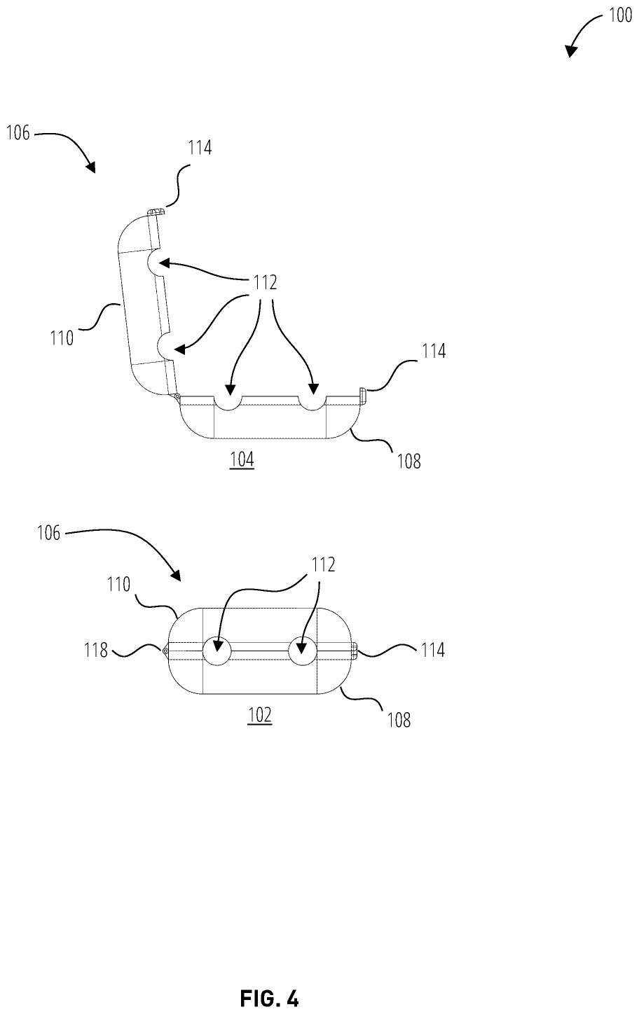

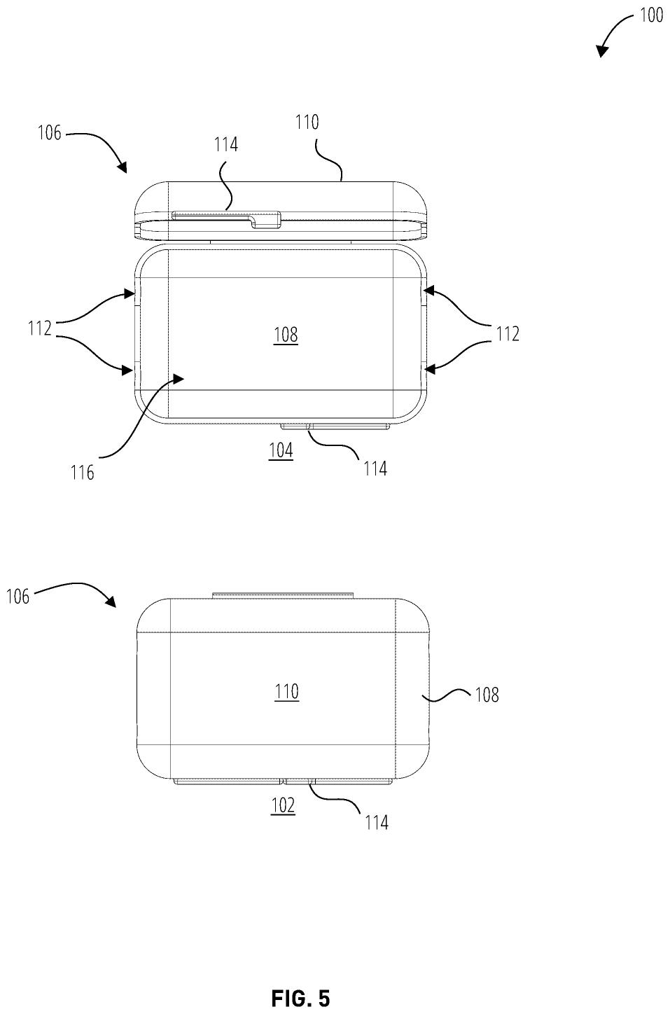

FIG. 1-FIG. 5 illustrate a cable securing apparatus 100 in various views and two configuration states (open configuration 104 and closed configuration 102). The cable securing apparatus 100 is provided as a means of enclosing the end terminal (e.g., device power connector, USB-C plug, lightning cable plug, etc.) of a cable to prevent adults, children, or animals from potentially harming themselves with the free end terminal (e.g., grabbing, sucking and chewing on, and having extended skin contact with the terminal end) when the cable is plugged into a live power socket. The cable securing apparatus 100 comprises a container 106 with a cover 110, a lower container 108, apertures 112, a closure 114, and an interior space 116.

The lower container 108 and the cover 110 of the container 106 form a housing that encloses an end terminal of a cable. The cover 110 is rotatably coupled with the lower container 108. In some configurations, this may be accomplished utilizing a pin-barrel hinge 118. The cover 110 and the lower container 108 may each be concave in shape with lateral walls surrounding a space on five sides. When closed, having the lower container 108 and cover 110 rotated towards each other by action at the hinge 118, the two joined may enclose the space in three dimensions, surrounding the space on six sides. The space is the interior space 116 of the container 106 where the end terminal of the cable may be positioned when enclosed within the cable securing apparatus 100.

The cover 110 and the lower container 108 may be similarly shaped components, but with a mirrored orientation. As such the rotation of the lower container 108 or the cover 110 relative to the other determines the configuration state of the cable securing apparatus 100.

The positioning of the cover 110 relative to the lower container 108 determines the configuration state (open configuration 104 or closed configuration 102) of the cable securing apparatus 100. When the cover 110 is coincident with the lower container 108, such that the concavities of the cover 110 and the lower container 108 are facing towards one another, the cable securing apparatus 100 is in a closed configuration 102. When the cover 110 is at an angled position to the lower container 108, or positioned in such a way where the concavities of the cover 110 and the lower container 108 are facing in the same direction, the cable securing apparatus 100 is in the open configuration.

The container 106 comprises apertures 112 that are configured to allow a cable to traverse into the container 106 and sized to prevent the terminal end of the cable from traversing the apertures 112. The apertures 112 may be configured as entry apertures and exit apertures that are oppositely positioned across the container 106. In the cable securing apparatus 100, the container 106 is configured with two sets of apertures 112. Each entry aperture of a set of apertures 112 is oppositely positioned across container 106. In the open configuration 104, portions of the apertures 112 are found on both the lower container 108 and the cover 110. The portions of the apertures 112 appear as half-moon cutouts on both the lower container 108 and the cover 110 that align to form the apertures 112 when the cable securing apparatus 100 is in the closed configuration 102. For the purposes of this disclosure, a cutout may be a notch, a recess, or some other substantially concave area where material is removed or omitted from a plane in order to allow ingress or egress of some object small enough to fit through the cutout, while blocking egress of larger bodies. In the closed configuration 102, each entry aperture of the set of apertures 112 is operatively aligned such that a cable is able to traverse the container 106 through both of the apertures 112 in a set.

The container 106 comprises a closure 114 that securely locks the lower container 108 to the cover 110 in the closed configuration 102. The closure 114 may be broken into two complementary parts found on the lower container 108 and the cover 110 that are operatively aligned to engage in the closed configuration 102. The closure 114 may be provided as child resistant or child safe locks that make it difficult for a child to open. The closure 114 may provide the container 106 with a secure closing mechanism to retain the terminal end of the cable within the interior space 116.

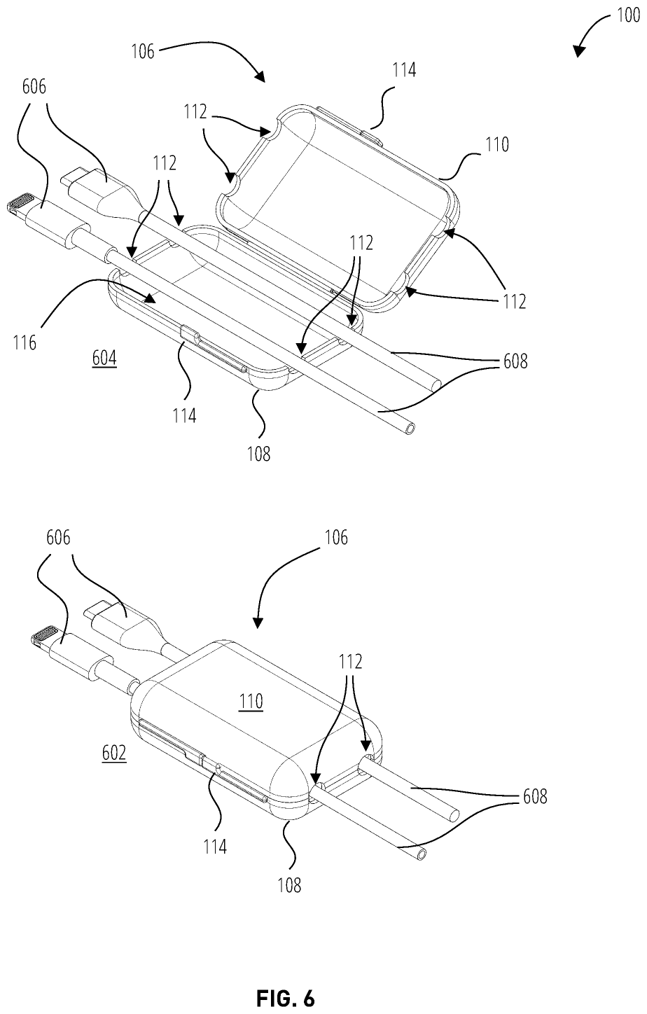

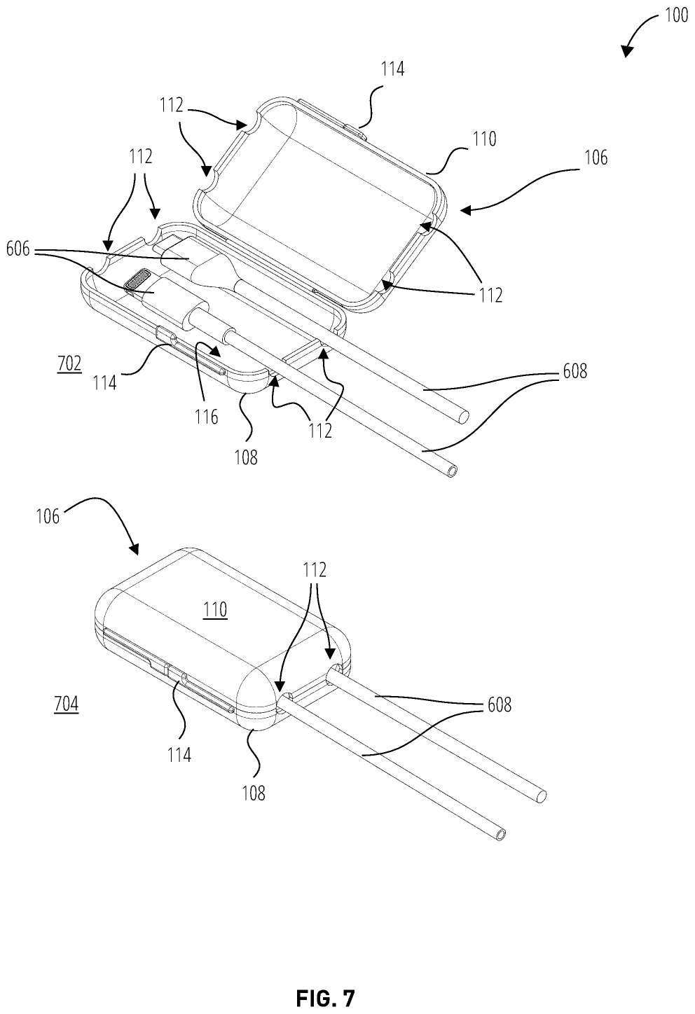

FIG. 6 and FIG. 7 illustrate a cable securing apparatus 100 in various views with cables 608 and the end terminals 606 of the cables arranged in different positions depending on the state of the cable securing apparatus 100.

In FIG. 6, the container 106 is shown in an open configuration 604 and a closed configuration 602. In the open configuration 604, the cables 608 are positioned within the portions of the apertures 112 and with the end terminals 606 positioned outside the container 106. The open configuration 604 may represent the instance where the user is installing the cable securing apparatus 100 onto the cables 608.

In the closed configuration 602, the cover 110 is secured to the lower container 108 and the apertures 112 surround the cables 608. The cables 608 are partially positioned within the interior space 116 of the container 106 with the end terminals 606 positioned outside of the container 106. The closure 114 is engaged preventing the container 106 being easily opened by a child. The closed configuration 602 may represent a configuration where the cable securing apparatus 100 is installed onto the cables 608 while still allowing the user to connect the end terminals 606 to their devices. In some configurations of the cable securing apparatus 100, the apertures 112 may be configured to engage the cables 608 such that in the closed configuration 602, the container 106 is retained in place on the cables 608. This may be accomplished through the sizing of apertures 112 or through flexible inserts that conform to the outside of the cables 608.

In FIG. 7, the container 106 is shown in an open configuration 702 and a closed configuration 704 where the end terminals 606 are positioned within the interior space 116 of the container 106. In the open configuration 702, the end terminals 606 are positioned within the interior space 116 of the lower container 108 with the cables 608 being aligned to an entry aperture of the set of apertures 112. The open configuration 702 may represent a configuration where the user is placing the end terminals 606 within the container 106 after they have finished using them.

In the closed configuration 704, the lower container 108 and the cover 110 enclose the end terminals 606 within the interior space 116 of the container 106. The cables 608 partially traverse into the container 106 through the apertures 112 but allow the end terminals 606 to be found enclosed within the container 106. The closure 114 is engaged preventing the separation of the cover 110 from the lower container 108 by a child, protecting a child from easily interacting with the end terminals 606 of the cables 608. The closed configuration 704 may represent a configuration where a user is securing the end terminals 606 from accidental contact and discharge. A user may access the end terminals 606 by disabling the closure 114 and separating the cover 110 from the lower container 108 to remove the end terminals 606.

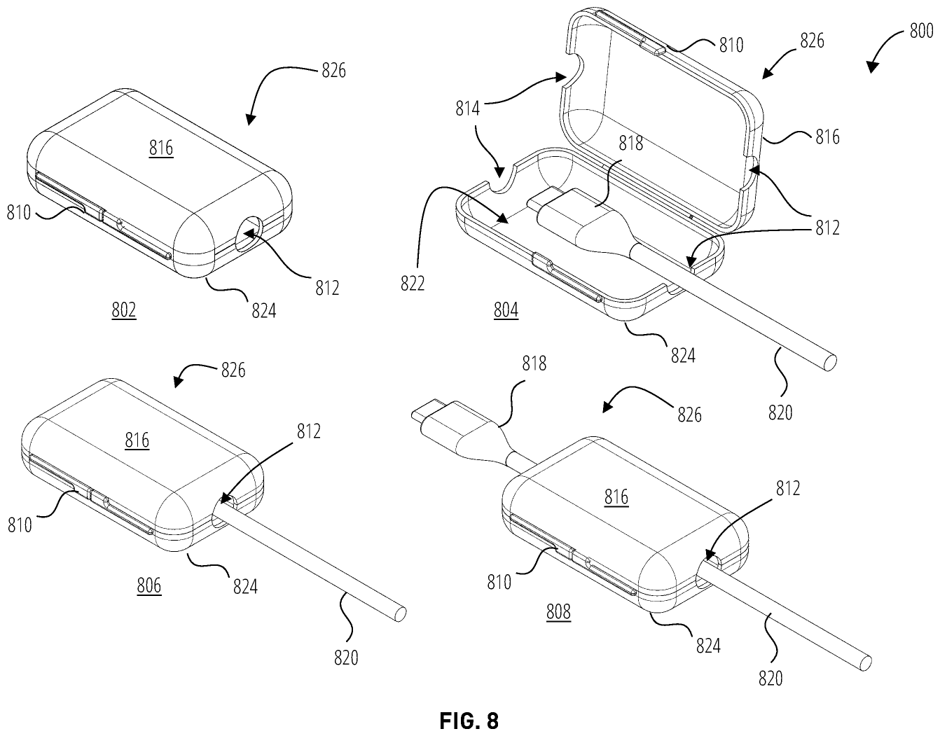

FIG. 8 illustrates a cable securing apparatus 800 configured with a single exit aperture 814. The cable securing apparatus 800 comprises a container 826 with a cover 816, a lower container 824, a closure 810, an entry aperture 812, an exit aperture 814, and an interior space 822.

The cable securing apparatus 800 is similar to the cable securing apparatus 100 but is configured to protect a single cable 820 and its end terminal 818. The cable securing apparatus 800 is shown in four different configurations dependent on the positioning of the cable 820 to the container 826.

In the closed configuration 802, the cover 816 and the lower container 824 are securely engaged by the closure 810 enclosing the interior space 822 of the container 826. Entry aperture 812 and exit aperture 814 (the latter not visible in this closed configuration 802 view) allow a cable to transverse the closed container 826.

In the open configuration 804, the cover 816 is positioned at an angle to the lower container 824 allowing a user to position the end terminal 818 into the interior space 822 or to place the cable 820 in the exit aperture 814. The exit aperture 814 is shown without the cable 820 or the end terminal 818 present. This configuration may represent a state where the user is positioning the end terminal 818 within the cable securing apparatus 800 for protection. This state may also represent a state where a user is attempting to remove the end terminal 818 from within the cable securing apparatus 800.

In the closed configuration 806, the cable securing apparatus 800 is shown with the end terminal 818 securely positioned within the container 826. The cover 816 and the cover lower container 824 are engaged by the closure 810 and the cable 820 traversing the entry aperture 812. This configuration may represent a state where the user has placed the end terminal 818 within the cable securing apparatus 800 for storage.

In the closed configuration 808, the cable securing apparatus 800 is shown with the end terminal 818 positioned outside of the container 826 with the cable 820 traversing the container 826 through the entry aperture 812 and the exit aperture 814 (the later is not visible in this view, though it is the means by which the cable 820 exits the interior space 822). The closure 810 locks the cover 816 and the lower container 824 in position preventing them from being opened accidentally or by a child or pet. This configuration may represent a state where the user is retaining the container 826 on the cable 820 while the end terminal 818 is in use.

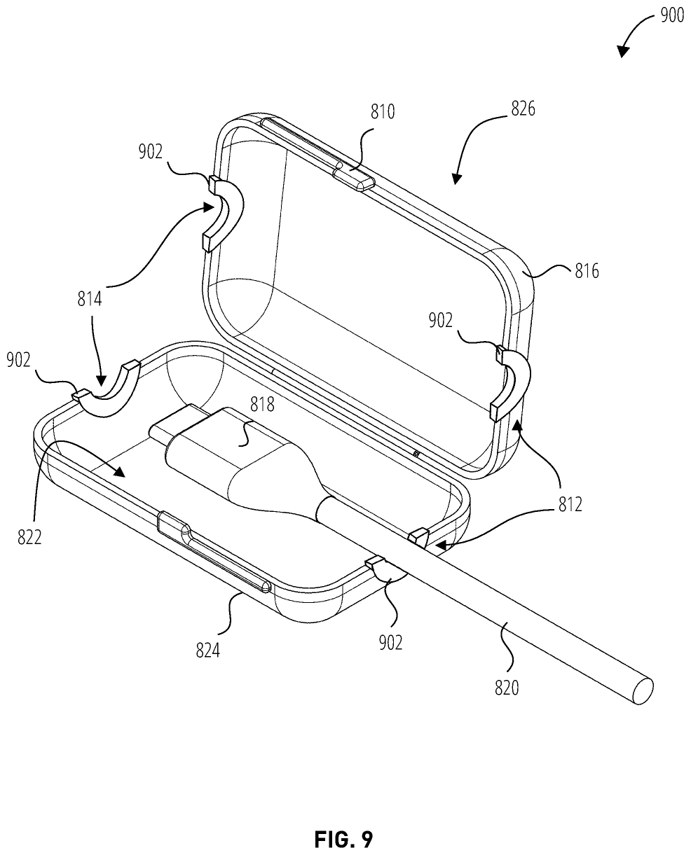

FIG. 9 illustrates a cable securing apparatus 900 in accordance with one embodiment. The cable securing apparatus 900 may comprise a closure 810, an entry aperture 812, an exit aperture 814, a cover 816, an interior space 822, a lower container 824, and a container 826 such as those introduced in FIG. 8. Also included in this figure are a cable 820 and its end terminal 818.

In some embodiments, the cable securing apparatus 900 may additionally comprise a seal 902 on at least one aperture, such that, when the container 826 is shut, the seal 902 may provide friction against the cable 820 in order to prevent the cable securing apparatus 800 from sliding along the length of the secured cable 820. Such seals 902 may be formed by split grommets of a flexible material, rubberized material deposited on the edges of the apertures, or of some other, similar composition. In some embodiments, seals 902 may be configured on each entry aperture 812 and each exit aperture 814, as shown in FIG. 9.

FIG. 10 illustrates views of a cable securing apparatus 1000 with a removable cover in an open configuration 1002 and a closed configuration 1004. The cable securing apparatus 1000 comprises a container 1018 with a cover 1014, a lower container 1016, apertures 1006, and interior space 1012. In the cable securing apparatus 1000, the cover 1014 may be slightly larger than the lower container 1016 allowing the cover 1014 to cap the lower container 1016. The cover 1014 and the lower container 1016 may be secured together through complementary locking features on the cover 1014 and the lower container 1016. These locking features may function similar to the locking devices and may be accomplished through a set of locking snaps.

The portions of the apertures 1006 are found on the cover 1014 and the lower container 1016 and securely retain a cable when the cable securing apparatus 1000 is in the closed configuration 1004. The cable securing apparatus 1000 comprises two sets of apertures 1006 that are oppositely positioned across the container 1018.

In the open configuration 1002, the cover 1014 is seen detached from the lower container 1016 and a set of cables 1010 are positioned in a set of apertures 1006 while the end terminals 1008 are positioned within the interior space 1012 of the container 1018. This configuration may represent a state where the user is storing the end terminals 1008 or attempting to remove the end terminals 1008 from the container 1018 for use.

In the closed configuration 1004, the cover 1014 is seen coupled to the lower container 1016 and the cables 1010 are shown partially traversing the container 1018 through the apertures 1006. This configuration may represent a state where the end terminals 1008 are being stored within the container 1018 to prevent a child from interacting with them or other forms of accidental contact.

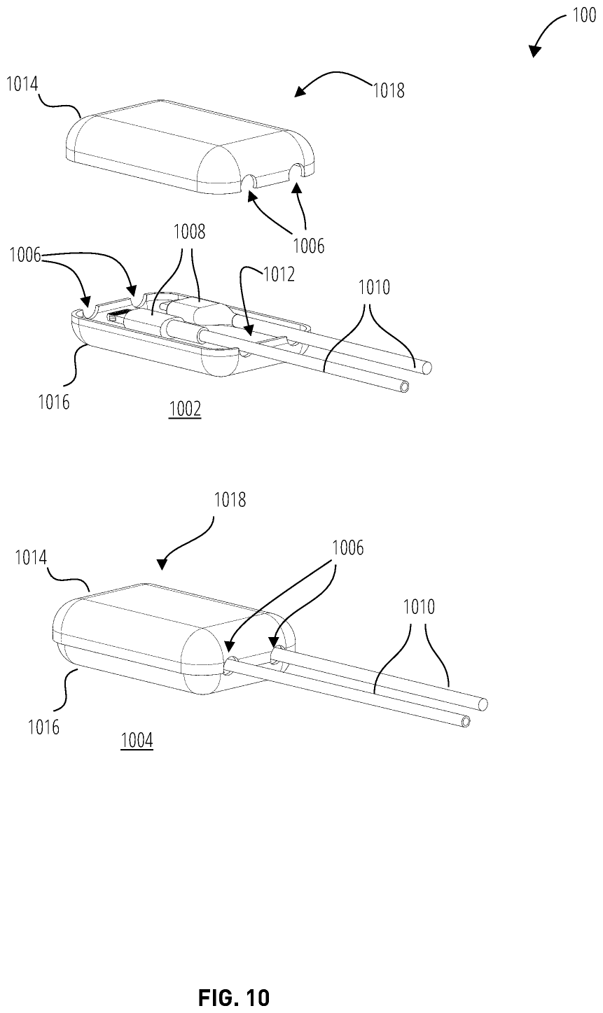

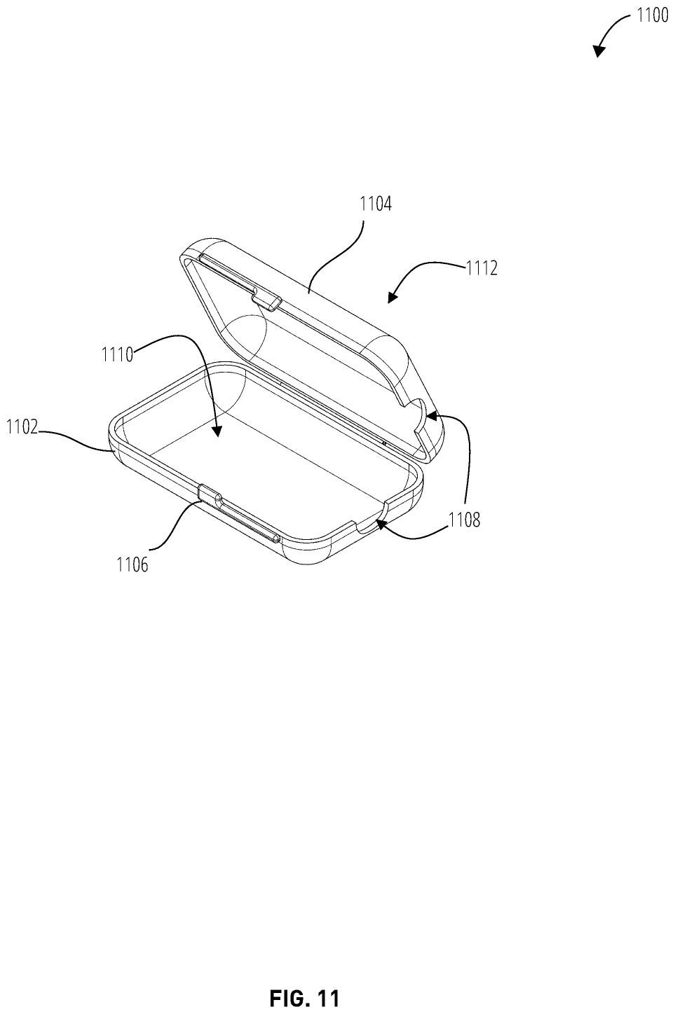

FIG. 11 illustrates a cable securing apparatus 1100 showing a single aperture 1108 positioned on one end of a container 1112. The cable securing apparatus 1100 comprises a container 1112 with a cover 1104, a lower container 1102, an aperture 1108, a closure 1106, and an interior space 1110. The cable securing apparatus 1100 may be provided as a configuration that serves to store the end terminal of a cable within the cable securing apparatus 1100 but lacks the option to retain the cable securing apparatus 1100 on the cable when the end terminal is in use. When the cable securing apparatus 1100 is in a closed configuration, the cover 1104 and the lower container 1102 may be engaged by the closure 1106 enclosing an end terminal within the container 1112. A user may remove the end terminal from the container 1112 by disengaging the closure 1106 and removing the end terminal from the interior space 1110.

FIG. 12 illustrates cable securing apparatus 1200 in various views showing a single-entry aperture and a flap 1216 oppositely positioned across the container 1220 in an open configuration 1204 and a closed configuration 1202. The cable securing apparatus 1200 comprises a container 1220 with a cover 1208, a lower container 1210, a closure 1206, an aperture 1212, an interior space 1214, a flap 1216, and a recessed opening 1218.

In the cable securing apparatus 1200, the cover 1208 is rotatably secured to the lower container 1210 and capable of being locked in place through the closure 1206. The flap 1216 is found positioned on the lower container 1210 with a recessed opening 1218 operatively aligned on the cover 1208. Portions of the aperture 1212 are found on both the cover 1208 and the lower container 1210 and align when in the closed configuration 1202 to form the aperture 1212. The interior space 1214 is surrounded by the walls of the lower container 1210 and the cover 1208 and accessible through the aperture 1212 and the flap 1216. The flap 1216 includes a protrusion pointing towards the aperture 1212 and at an angle pointing towards the cover 1208 when in the closed configuration 1202. The flap 1216 may be able to flex when pressure is applied to the protrusion.

The cable securing apparatus 1200 is provided to allow a user to position a cable across the container 1220 traversing through the aperture 1212 and the flap 1216. The end terminal of the cable would be positioned proximal to flap 1216 and the recessed opening 1218. When the cable securing apparatus 1200 is in the closed configuration 1202, the aperture 1212 would secure a portion of the cable while the flap 1216 and the recessed opening 1218 would secure the portion of the cable proximal to the end terminal. The recessed opening 1218 provides a gap for the cable when the cable securing apparatus 1200 is in the closed configuration 1202. The recessed opening 1218 may be provided to reduce pressure on the cable that could potentially damage the cable.

When a user is utilizing the end terminal of a cable, the cable securing apparatus 1200 may rest on the cable secured by the flap 1216 and the aperture 1212. Alternatively, the flap 1216 may serve as the manner by which the container 1220 is secured to the cable. When a user wishes to store the end terminal within the cable securing apparatus 1200, the user may pull the cable from the side closest to the aperture 1212. The end terminal of the cable may then depress the flap 1216 and traverse into the interior space 1214 of the container 1220. The recessed opening 1218 may provide additional clearance to the end terminal while it enters the container 1220. The recessed opening 1218 may serve to prevent the flap 1216 from over-flexing and deforming. The protrusion of the flap 1216 may act as a one-way mechanism preventing the end terminal from exiting the container 1220 through the same direction that it entered. When the user wishes to retrieve the end terminal, the user may disable the closure 1206 and open the container 1220.

In some configurations, the flap 1216 may be constructed of a different material from the container 1220. The different material construction of the flap 1216 may be provided for better flexibility compared to the materials utilize by the container. The flap 1216 may be separately installed on to the container 1220 through different means (e.g., glued using an adhesive) and may be constructed of a soft plastic or rubber material.

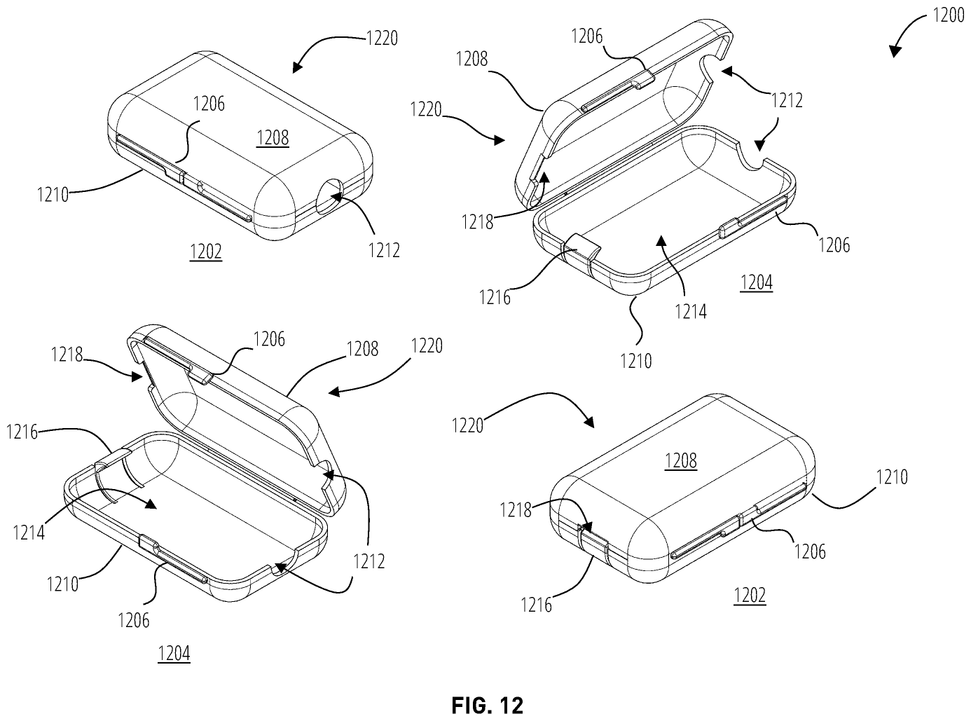

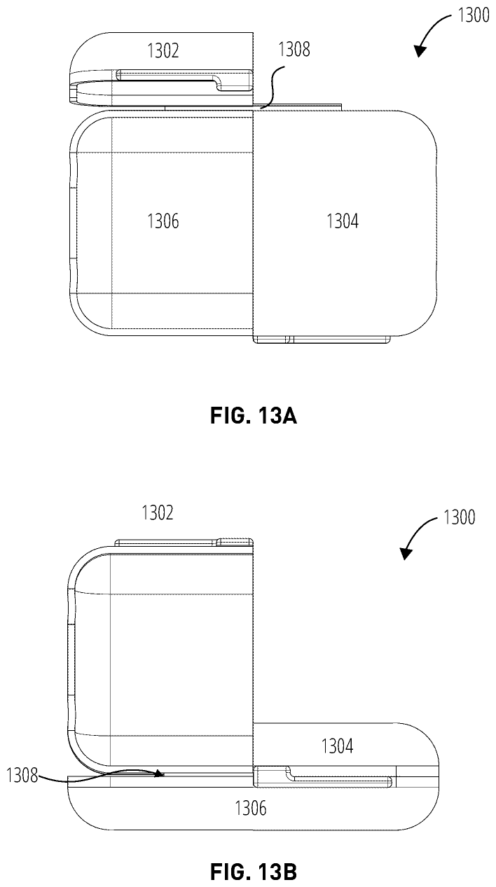

FIG. 13A illustrates a top view of a cable securing apparatus 1300 in accordance with one embodiment. FIG. 13B illustrates a plan view of the cable securing apparatus 1300. The cable securing apparatus 1300 comprises a first independently rotatable cover portion 1302, a second independently rotatable cover portion 1304, a container 1306, and a hinge 1308. First independently rotatable cover portion 1302, second independently rotatable cover portion 1304, and container 1306 may be configured with cutouts (not shown) to provide at least one entry aperture.

In this embodiment, the first independently rotatable cover portion 1302 and second independently rotatable cover portion 1304 may both be connected by the hinge 1308 to the container 1306, but may be independently latched and unlatched to the container. In this manner, one or both of first independently rotatable cover portion 1302 and second independently rotatable cover portion 1304 may be unlatched to allow a cable to be secured within the cable securing apparatus 1300, aligned with the entry aperture (not shown), and one of the first independently rotatable cover portion 1302 or the second independently rotatable cover portion 1304 may be subsequently unlatched to allow one end of the cable to exit the cable securing apparatus 1300 for use and be re-secured within the cable securing apparatus 1300 when not in use, keeping the cable securing apparatus 1300 securely connected to the cable at all times.

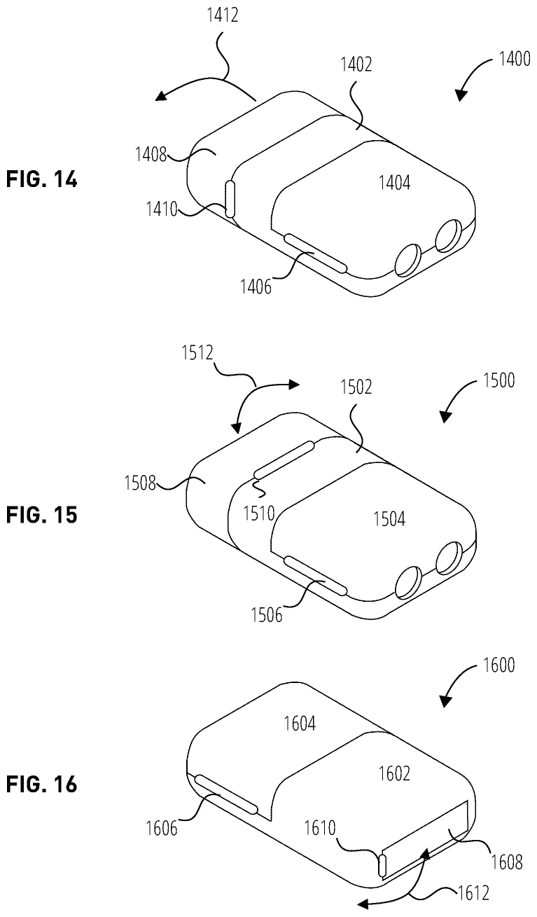

FIG. 14 illustrates a cable securing apparatus 1400 having a flip top lid similar to a butane lighter in one embodiment. The cable securing apparatus 1400 comprises a container 1402, a first independently rotatable cover portion 1404, a first hinge 1406, a second independently rotatable cover portion 1408, and a second hinge 1410. The container 1402, and first independently rotatable cover portion 1404 may be configured with cutouts as shown to provide at least one entry aperture.

The first independently rotatable cover portion 1404 may be unlatched from the container 1402 and rotated open around the first hinge 1406. The cable end terminal may be inserted into the container 1402 through the entry aperture(s), and the first independently rotatable cover portion 1404 may then be latched again, securing the cable within the cable securing apparatus 1400.

To use the cable for charging, the second independently rotatable cover portion 1408 may be unlatched from the container 1402 and rotated open around the second hinge 1410, across the rotation direction 1412 shown. The second independently rotatable cover portion 1408 may remain open during charging, or may include at least one cutout allowing it to be latched shut during charging.

For ease of illustration, a portion of the container 1402 is shown between the first independently rotatable cover portion 1404 and the second independently rotatable cover portion 1408. In some embodiments, however, the first independently rotatable cover portion 1404 and second independently rotatable cover portion 1408 may abut each other.

FIG. 15 illustrates a cable securing apparatus 1500 having a flip top lid similar to a cigarette carton in one embodiment. The cable securing apparatus 1500 comprises a container 1502, a first independently rotatable cover portion 1504, a first hinge 1506, a second independently rotatable cover portion 1508, and a second hinge 1510. The container 1502 and first independently rotatable cover portion 1504 may be configured with cutouts as shown to provide at least one entry aperture.

The first independently rotatable cover portion 1504 may be unlatched from the container 1502 and rotated open around the first hinge 1506. The cable end terminal may be inserted into the container 1502 in alignment with an entry aperture, and the first independently rotatable cover portion 1504 may then be latched again, securing the cable within the cable securing apparatus 1500.

To use the cable for charging, the second independently rotatable cover portion 1508 may be unlatched from the container 1502 and rotated open around the second hinge 1510, across the rotation direction 1512 shown. The second independently rotatable cover portion 1508 may remain open during charging, or may include at least one cutout allowing it to be latched shut during charging.

For ease of illustration, a portion of the container 1502 is shown between the first independently rotatable cover portion 1504 and the second independently rotatable cover portion 1508. In some embodiments, however, the first independently rotatable cover portion 1504 and second independently rotatable cover portion 1508 may abut each other.

FIG. 16 illustrates a cable securing apparatus 1600 having a flip top opening similar to a breath mint container in one embodiment. The cable securing apparatus 1600 comprises a container 1602, a first independently rotatable cover portion 1604, a first hinge 1606, a second independently rotatable cover portion 1608, and a second hinge 1610. The container 1602 and first independently rotatable cover portion 1604 may be configured with cutouts to provide at least one entry aperture (not shown).

The first independently rotatable cover portion 1604 may be unlatched from the container 1602 and rotated open around the first hinge 1606. The cable end terminal may be inserted into the container 1602 in alignment with an entry aperture, and the first independently rotatable cover portion 1604 may then be latched again, securing the cable within the cable securing apparatus 1600.

To use the cable for charging, the second independently rotatable cover portion 1608 may be unlatched from the container 1602 and rotated open around the second hinge 1610, across the rotation direction 1612 shown. The second independently rotatable cover portion 1608 may remain open during charging, or may include at least one cutout allowing it to be latched shut during charging.

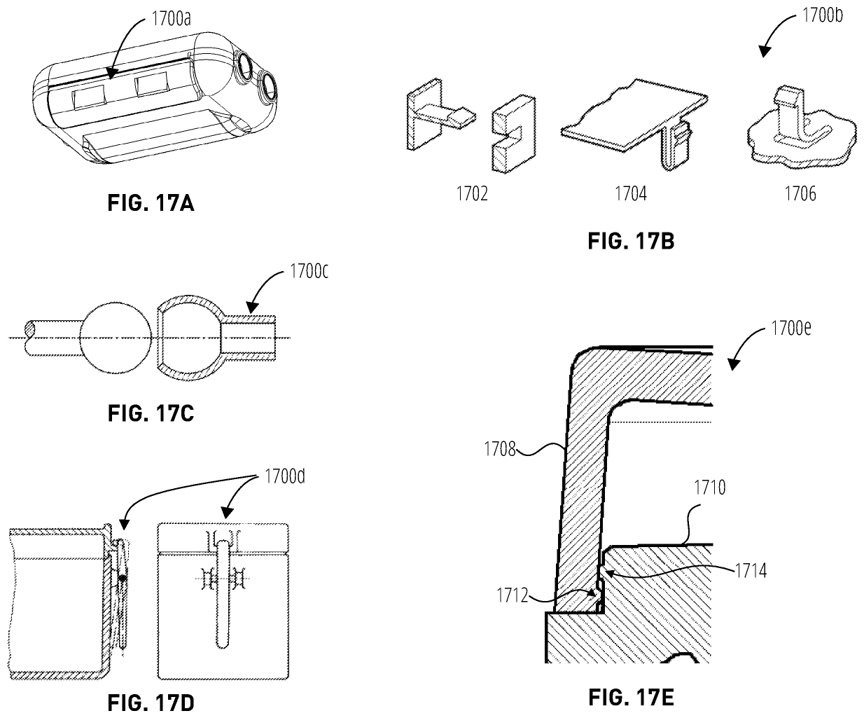

FIG. 17A-FIG. 17E illustrate basic snap-fit latch or closures that may be used to secure the cover to the container in some embodiments of the disclosed cable securing apparatus. “Snap-fit closure” refers to a latch utilizing a small protrusion (hook, stud, or bead) which is deflected during assembly to catch in a depression on the mating part. The depression on the mating part may be beveled such that, while it securely holds the protrusion at equilibrium, the beveled edge may act to deflect the latching portion when a force is exerted, allowing the protrusion to disengage from the depression. In other embodiments, the latching portion may be deflectable by a force exerted in order to disengage the protrusion from the depression, allowing the latching portion to be pulled away from its mating part.

FIG. 17A illustrates a hinged-latch snap-fit closure 1700a. FIG. 17B illustrates cantilever snap-fit closures 1700b, including a plain cantilever snap-fit closure 1702, a U-shaped cantilever snap-fit closure 1704, and an L-shaped cantilever snap-fit closure 1706. FIG. 17C illustrates an annular snap-fit closure 1700c. FIG. 17D illustrates a torsion snap-fit closure 1700d.

FIG. 17E illustrates a latch-bead snap-fit closure 1700e. A cover 1708 may incorporate one or more discrete cover latch beads 1712 or one continuous cover latch bead 1712 around its inner circumference. These may engage lockingly with one or more discrete or one continuous container latch beads 1714 configured around the outer circumference of a face of the container 1710 configured to be adjacent to the cover 1708 when the container 1710 is closed by the cover 1708.

Other embodiments may utilize screw-on closures, snap-on closures, or friction-fit closures, not illustrated herein, which are well understood in the art. The latch and closure types listed and illustrated herein are intended for exemplary purposes only and are not intended to limit the disclosed embodiments.

In some embodiments, the closures utilized may be configured such that minimal manual dexterity or strength is needed to open the apparatus, rendering the apparatus secure from opening by small children. Such closures may be similar to those described herein but may be additionally described as “child-proof,” “child-resistant,” or “safety” closures.

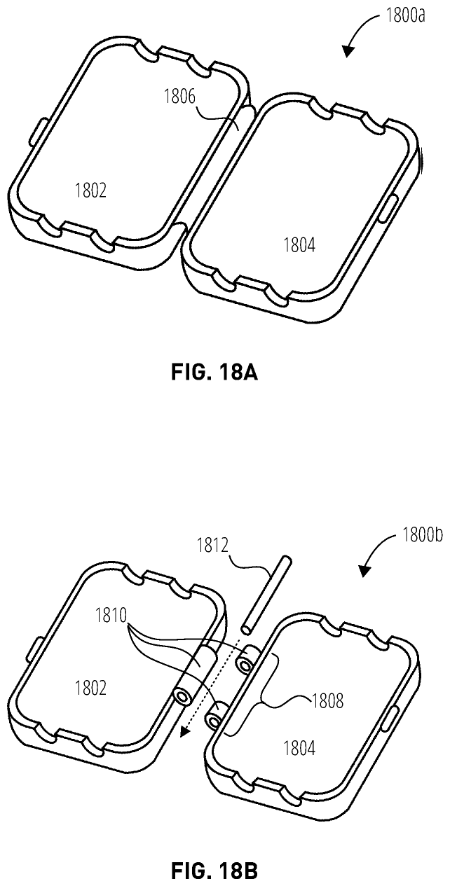

FIG. 18A illustrates a cable securing apparatus 1800a in accordance with one embodiment. The cable securing apparatus 1800a comprises a cover 1802 and a container 1804 connected by a living hinge 1806. “Living hinge” refers to a thin, flexible hinge made from the same material as the two rigid pieces it connects. It may be thinned or cut to allow the rigid pieces to bend along the line of the hinge.

FIG. 18B illustrates a cable securing apparatus 1800b in accordance with one embodiment. The cable securing apparatus 1800b comprises a cover 1802, a container 1804 similar to those illustrated in FIG. 18A but in this embodiment connected by a three-part hinge 1808.

The three-part hinge 1808 in one embodiment may comprise cylindrical or barrel type protrusions incorporated into the container 1804 and cover 1802, each protrusion including a central hole running along its linear axis. Bringing the container 1804 and cover 1802 together as shown by the solid arrow may align the cylindrical protrusions with central holes 1810, such that a hinge pin 1812 may be slid through all of the central holes in the direction shown by the dotted arrow, creating a hinge joint around which the container 1804 and cover 1802 may rotate away from and toward each other, in order to open and close the cable securing apparatus 1800b.

### LISTING OF DRAWING ELEMENTS

100 cable securing apparatus
102 closed configuration
104 open configuration
106 container
108 lower container
110 cover
112 apertures
114 closure
116 interior space
118 hinge
602 closed configuration
604 open configuration
606 end terminals
608 cables
702 open configuration
704 closed configuration
800 cable securing apparatus
802 closed configuration
804 open configuration
806 closed configuration
808 closed configuration
810 closure
812 entry aperture
814 exit aperture
816 cover
818 end terminal
820 cable
822 interior space
824 lower container
826 container
900 cable securing apparatus
902 seal
1000 cable securing apparatus
1002 open configuration
1004 closed configuration
1006 apertures
1008 end terminals
1010 cable
1012 interior space
1014 cover
1016 lower container
1018 container
1100 cable securing apparatus
1102 lower container
1104 cover
1106 closure
1108 aperture
1110 interior space
1112 container
1200 cable securing apparatus
1202 closed configuration
1204 open configuration
1206 closure
1208 cover
1210 lower container
1212 aperture
1214 interior space
1216 flap
1218 recessed opening
1220 container
1300 cable securing apparatus
1302 first independently rotatable cover portion
1304 second independently rotatable cover portion
1306 container
1308 hinge
1400 cable securing apparatus
1402 container
1404 first independently rotatable cover portion
1406 first hinge
1408 second independently rotatable cover portion
1410 second hinge
1412 rotation direction
1500 cable securing apparatus
1502 container
1504 first independently rotatable cover portion
1506 first hinge
1508 second independently rotatable cover portion
1510 second hinge
1512 rotation direction
1600 cable securing apparatus
1602 container
1604 first independently rotatable cover portion
1606 first hinge
1608 second independently rotatable cover portion
1610 second hinge
1612 rotation direction
1700a hinged-latch snap-fit closure
1700b cantilever snap-fit closures
1700c annular snap-fit closure
1700d torsion snap-fit closure
1700e latch-bead snap-fit closure
1702 plain cantilever snap-fit closure
1704 U-shaped cantilever snap-fit closure
1706 L-shaped cantilever snap-fit closure
1708 cover
1710 container
1712 cover latch bead
1714 container latch bead
1800a cable securing apparatus
1800b cable securing apparatus
1802 cover
1804 container
1806 living hinge
1808 three-part hinge
1810 cylindrical protrusion with central hole
1812 hinge pin

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

What is claimed is:

1. A cable securing apparatus comprising:
a container including:
a space configured to accept a portion of a cable with an end terminal;
at least one entry aperture configured to accept the portion of the cable with the end terminal, wherein the at least one entry aperture facilitates entry of the portion of the cable with the end terminal into the space from outside of the container, and prevents the end terminal from sliding out of the at least one entry aperture;
a cover securable to the container such that the portion of the cable and the end terminal are enclosable within the container; and
a closure configured to secure the cover to the container.

2. The cable securing apparatus of claim 1, wherein the container with a secured cover is a child resistant container.

3. The cable securing apparatus of claim 1, wherein the closure is at least one of a hinged-latch snap-fit closure, a cantilever snap-fit closure, a torsion snap-fit closure, an annular snap-fit closure, a screw-on closure, a snap-on closure, and a friction-fit closure.

4. The cable securing apparatus of claim 1, further comprising a seal on the at least one entry aperture.

5. The cable securing apparatus of claim 1, wherein the cover is rotatably securable to the container and a hinge connects the cover to the container.

6. The cable securing apparatus of claim 5, wherein the hinge is a living hinge.

7. The cable securing apparatus of claim 5, wherein the hinge is a three-part hinge.

8. The cable securing apparatus of claim 5, wherein the cover comprises at least two independently rotatable cover portions connected to the container by the hinge.

9. The cable securing apparatus of claim 5, wherein the hinge is a first hinge and the cable securing apparatus further comprises a second hinge, the cover comprising at least two independently rotatable cover portions, wherein a first independently rotatable cover portion connects to the container with the first hinge and a second independently rotatable cover portion connects to the container with the second hinge.

10. The cable securing apparatus of claim 1, further comprising at least one exit aperture on the container configured to accept the portion of the cable.

11. The cable securing apparatus of claim 10, further comprising a seal on the at least one exit aperture.

12. A method of securing a cable, the method comprising:
placing a portion of the cable with an end terminal into a container,
the container comprising:
a space configured to accept the portion of the cable with the end terminal;
at least one entry aperture configured to accept the portion of the cable with the end terminal, wherein the at least one entry aperture facilitates entry of the portion of the cable with the end terminal into the space from outside of the container, and prevents the end terminal from sliding out of the at least one entry aperture;
a cover securable to the container such that the portion of the cable and the end terminal are enclosed within the container; and
a closure configured to secure the cover to the container; and
closing the cover on the container, thereby securing the cable and the end terminal.

13. The method of claim 12, wherein the container with the secured cable is a child resistant container.

14. The method of claim 12, wherein the closure is at least one of a hinged-latch snap-fit closure, a cantilever snap-fit closure, a torsion snap-fit closure, an annular snap-fit closure, a screw-on closure, a snap-on closure, and a friction-fit closure.

15. The method of claim 12, the container further comprising a seal on the at least one entry aperture.

16. The method of claim 12, the container further comprising a hinge connecting the cover to the container, thereby making the cover rotatably securable to the container.

17. The method of claim 16, wherein the hinge is a living hinge.

18. The method of claim 16, wherein the hinge is a three-part hinge.

19. The method of claim 12, wherein the container further comprises at least one exit aperture on the container configured to accept the portion of the cable, the method further comprising:
opening the closed container;
removing the end terminal the cable from the container such that the cable exits the container through the at least one exit aperture;
closing the cover on the container, thereby securing the cable.

20. The method of claim 19, the container further comprising a seal on the at least one exit aperture.
